(19) United States
(12) Patent Application Publication
(10) Pub. No.: US 2015/0077984 A1
(43) Pub. Date: Mar. 19, 2015

(54) Array of LED lights optimized to produce light at the peack absorbance frequencies of the primary molecules involved in photosynthesis and plant growth

(71) Applicant: Daniel Smith, Colorado Springs, CO (US)

(72) Inventor: Daniel Smith, Colorado Springs, CO (US)

(21) Appl. No.: 13/987,904

(22) Filed: Sep. 16, 2013

(51) Int. Cl. F21K 99/00; A01G 7/04; H05B 33/08

(52) U.S. Cl. CPC F21K 9/00; H05B 33/0803; A01G 7/045
USPC 362/231

(57) ABSTRACT

An Assembly is provided to produce light at the frequencies most readily absorbed by the primary molecules involved in the photosynthetic process, Chlorophyll A, Chlorophyll B, Beta-Carotene, P680 and P700.

### REFERENCES CITED

U.S. Pat. No. 6,921,182 B2 SolarOasis 26 Jul. 2005

U.S. patent application Ser. No. 13/404,907, Publication No US 2012/0218750 (published Aug. 30 2012)(Nicholas Peter Klase et al, applicants)

U.S. patent application Ser. No. 13/241,646, Publication No US 2012/0075848 (published Mar. 29, 2012)(Makato Yamada et al, applicants)

U.S. patent application Ser. No. 12/772,734, Publication No US 2010/0277078 A1 (published Nov. 4 2010)(David L. Morton, applicant)

U.S. patent application Ser. No. 11/162,433, Publication No US 2007/0058268 A1 (published Mar. 15 2007)(Adam Mark Partee et al, applicants)

### STATEMENT REGARDING FEDERALLY SPONSORED RESEARCH OR DEVELOPMENT

Not Applicable

### REFERENCE TO A SEQUENCE LISTING, A TABLE, OR A COMPUTER PROGRAM, LISTING COMPACT DISC APPENDIX

Not Applicable

### BACKGROUND OF THE INVENTION

Since the advent of artificial lighting, there have been attempts made to produce lighting that will drive plant growth. Some success has been found using metal halide, sodium vapor or other “conventional” light sources that can produce sufficient light energy to produce vigorous plant growth. The main drawback to such lighting approaches is the high energy consumption required to generate the light. The inefficiency in these approaches derives primarily from the fact that the light that they produce is broad in spectrum. This means that much of the light spectrum produced is unused or used very inefficiently by the plant. The energy consumed to produce that portion of the lighting spectrum unused by the plant is wasted.

Photosynthesis, the photochemical process by which plants convert light, water, CO2 and trace minerals into ATP and NAPDH to produce the carbohydrates used by the plant for growth, is done by the combined action of several molecules contained within the leaves. These process have been extensively researched and the information is widely available. The research reveals that for leafy green plants the primary reducing molecule involved in the photosynthetic reactions is Chlorophyll A P680, or P680, in the plants photosystem II, and the primary oxidizing molecule active in photosynthesis is Chlorophyll A P700, or P700, in the plants photosystem I. In addition to those molecules there are auxiliary pigments that act as a light gathering “antenna” system for plants, primarily Chlorophyll A, Chlorophyll B, and Beta-Carotene. (The reactions can be seen at http://chemwiki.ucdavis.edu/Biological_Chemistry/Photosynthesis/Photosynthesis_overview/The_Light_Reactions and many other places).

These molecules are tuned by their structures to absorb light energy most efficiently at specific wavelengths. The peak absorption wavelengths of P680 and P700 are 680 nm and 700 nm respectively. The absorbance peaks for Chlorophyll A are 430 nm and 664 nm, the peaks for Chlorophyll B are 460 nm and 647 nm, the absorbance peaks for Beta-Carotene are 450 nm and 480 nm.

The advent of Light Emitting Diodes, or LEDs, has given us access to a light source that efficiently produces light in narrow frequency ranges, and presented an opportunity to create a plant light that produces light only at those specific frequencies most readily absorbed by the plant for photosynthesis.

Prior art LED based plant lights do not provide the plants light at all of the required frequencies, often produce light at frequencies not readily absorbed by the plants photochemical systems and sometimes employ techniques that lower the light emission efficiency of the LEDs.

In order to realize the efficiency potential of LED lighting for leafy green plant growth, there is a need for an improved LED light source that will provide light at the frequencies identified above to potentiate photosynthesis and which does not use electricity to produce light at frequencies not used or used inefficiently by the plant.

### SUMMARY OF THE INVENTION

The device described herein provides a system and method for improving all prior art LED plant lighting systems by producing light at all of the identified peak absorbance frequencies for the primary molecules involved in leafy green plant photosynthesis and by not wasting energy creating light at frequencies unused or inefficiently used by plants. By using LEDs manufactured to produce the specific frequencies noted above we can match the emission frequency of the LEDs to the absorbance peaks of the molecules involved in photosynthesis.

This device is an assembly that consists of an array or arrays of LEDs, the elements of which produce light at as close to 430 nm, 450 nm, 460 nm, 664 nm, 647 nm, 480 nm, 680 nm and 700 nm as the manufacturing process allows mounted within a case and including a power supply sized to drive the specific LEDs in use. The device can be produced in a number of configurations that meet the criteria specified.

### BRIEF DESCRIPTION OF THE DRAWINGS

For a better understanding of the invention, reference is made to the accompanying drawings, which are incorporated herein by reference, and in which:

FIG. 1 is a schematic of the electrical circuit of an LED array or sub-array

FIG. 2 is a perspective view of the elements of example 1 of the plant light assembly.

FIG. 3 is a perspective view of the elements of example 2 of the plant light assembly.

### DETAILED DESCRIPTION

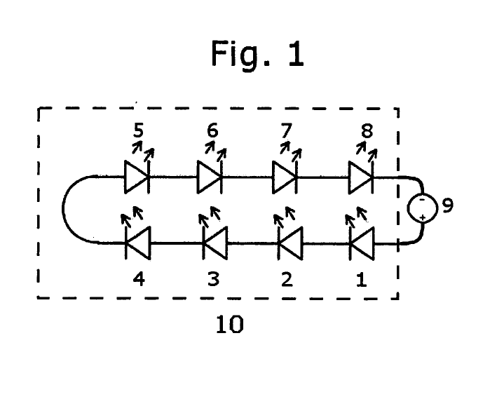

An Assembly 15, 16 consisting of a Light Producing Array or Sub-array 10 as indicated in FIG. 1, a case 11, a clear protective cover 12, electrical conductors 13, and a power supply 9.

The array or sub-array 10 in FIG. 1 is composed of LEDs selected to potentiate specific molecules in a plants photosynthetic systems, and the associated electrical circuit hardware.

LED 1 is 430 nm targeting Chlorophyll A.

LED 2 is 664 nm targeting Chlorophyll A.

LED 3 is 460 nm targeting Chlorophyll B.

LED 4 is 647 nm targeting Chlorophyll B.

LED 5 is 450 nm targeting Beta-Carotene.

LED 6 is 480 nm targeting Beta-Carotene.

LED 7 is 680 nm targeting P680.

LED 8 is 700 nm targeting P700.

The Assemblies 15, 16 can be in a wide variety of configurations consisting of multiples of Array 10.

For larger arrays assemblies, the ratio of the constituent LEDs may be varied as long as all light frequencies identified above are generated.

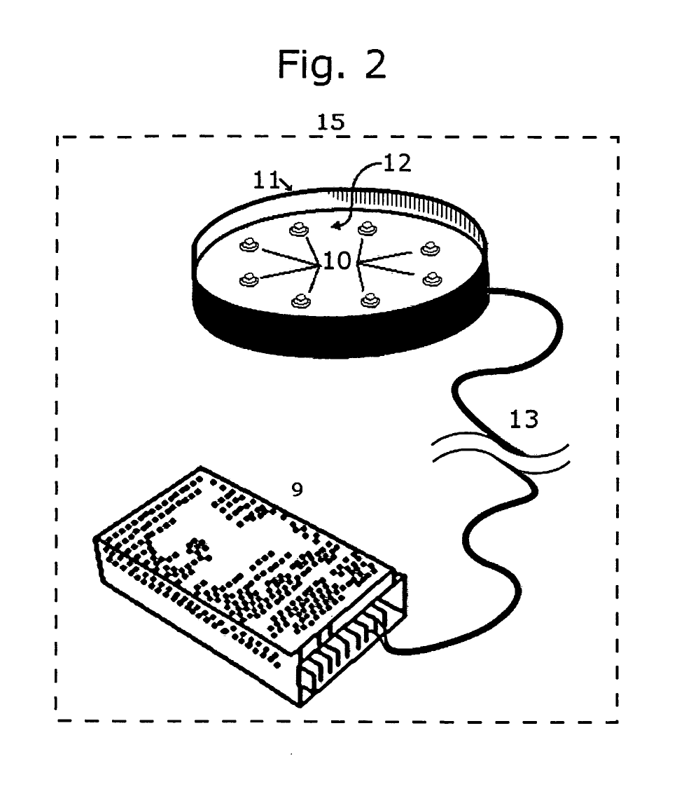

FIG. 2 illustrates an example Assembly 15 that is a single array 10, the case 11, the clear protective cover 12, and the power supply 9.

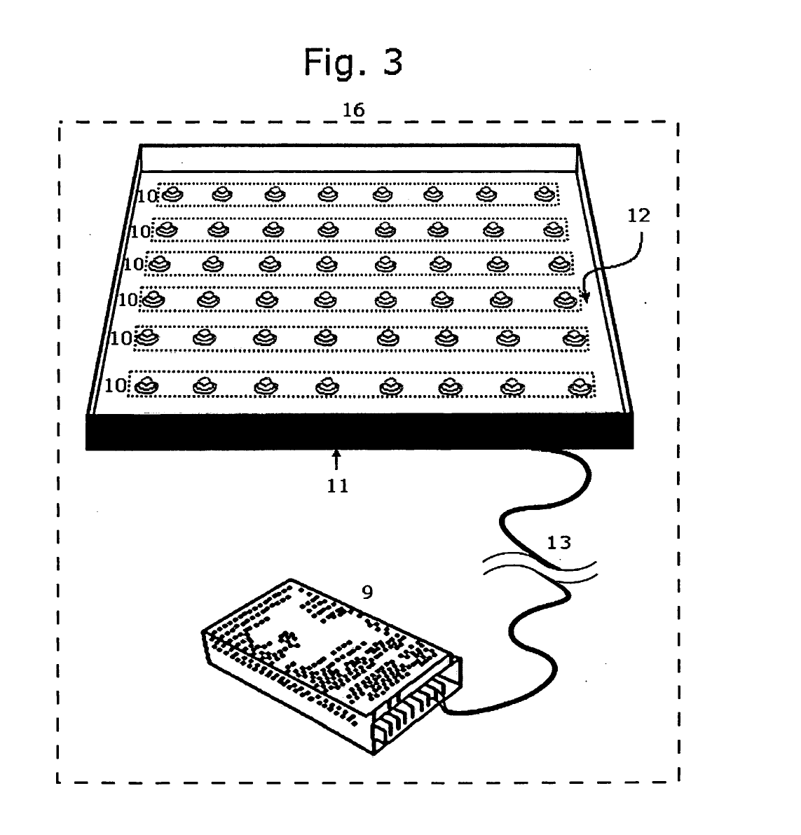

FIG. 3 illustrates an example Assembly 16 that is an Array of 6 sub-arrays 10, the case 11, the clear protective cover 12, and the power supply 9.

Assemblies may also include heat sinks and fans in some configurations.

What is claimed is:

1. A device consisting of an array or arrays of Light Emitting Diodes, or LEDs, a power supply or driver, electrical circuitry and a case for mounting and protecting the LEDs which produces light at the frequencies of 430 nm, 450 nm, 460 nm, 664 nm, 647 nm, 480 nm, 680 nm and 700 nm required for vigorous leafy green plant growth.

2. A device defined in claim 1 that efficiently potentiates the photosynthetic reactions in leafy green plants by producing light at the frequencies most readily absorbed by the Chlorophyll A, Chlorophyll B, Beta-Carotene, P680 and P700 molecules.

3. A device defined in claim 1 that improves on all prior art LED based plant lights by producing light at the frequencies most readily absorbed by the primary molecules involved in photosynthesis and not producing light at frequencies not readily absorbed by those molecules.
